(19) United States
(12) Patent Application Publication
(10) Pub. No.: US 2008/0073304 A1
(43) Pub. Date: Mar. 27, 2008

(54) Collapsible transport frame

(75) Inventor: James Corbett, New South Wales (AU)

Correspondence Address: Charles N.J. Ruggiero;Ohlandt, Greeley, Ruggiero & Perle, L.L.P., 10th Floor, One Landmark Square, Stamford, CT, 06901-2682, US

(73) Assignee: HERDGRAPH PTY LTD.

(21) Appl. No.: 11/891,440

(22) Filed: Aug. 10, 2007

(30) Foreign Application Priority Data
Aug. 11, 2006 (AU) 2006904379

(51) Int. Cl. A47B 47/00; B60B 33/04; B60B 33/08

(52) U.S. Cl. 211/198; 16/19; 16/24

(57) ABSTRACT

A collapsible transport frame 10 for transporting sheet material includes a first support frame 11, a second support frame 12, a bracing arrangement 16, 17. The bracing arrangement 16, 17 is connected to and extends between the first and second support frames 11, 12 which permits movement of the first support frame 11 relative to the second support frame 12, between an expanded sheet support condition and a collapsed condition; such that, in the expanded sheet support condition, the first and second support frames 11, 12 are braced in a spaced apart relationship and in the collapsed condition, the first and second support frames 11, 12 are substantially adjacent. The first support frame 11 includes a wheel arrangement 20 for engagement with a surface on which the transport frame 10 is supported, the wheel arrangement 20 facilitating movement of the first support frame 11 relative to the second support frame 12 such that the first support frame 11 is movable in the collapsed condition away from the second support frame 12 to the expanded condition and towards the second support frame 12 from the expanded condition to the collapsed condition.

### FIELD OF THE INVENTION

This invention relates to transport frames for supporting sheet materials such as marble or glass during transport thereof, and more particularly the invention relates to portable transport support frames.

### BACKGROUND OF THE INVENTION

Support frames are used in the construction industry for moving heavy, fragile or difficult to carry sheet materials such as glass, fiberglass, marble or concrete. Transport frames for such materials are usually large in size and weight as they must be able to carry heavy materials of large dimensions, particularly in the case of marble and glass material. Existing support frames usually support the material to be transported in an inclined but upright condition. Existing transport frames usually are fixed to the tray of a truck although they can be portable.

In some forms of portable support frames the frame can be expanded and collapsed, however, a problem with these frames is that they are difficult for an operator to easily move the frame between the collapsed and expanded position. Common collapsible A-frames are generally bolted together. It is normal that two operators are required for this operation.

The major advantage of a collapsible A-frame is its compactness and portability when collapsed. This allows truck operators to carry the frame on trucks with other loads, which allows truck operators to pick up loads of sheet material after delivery of other goods without having to return to base to pick up a bulky fixed A-frame and vice versa, after delivery of sheet material the frames can be folded up, allowing the truck operator to pick up bulky goods without off loading the fixed A-frames. Also carriers and contractors can deliver to interstate destinations and then have the frame sent back to the wholesaling yard or distributor at a very reasonable freight rate, as the frames when folded take up very little space.

The above discussion of background art is included to explain the context of the present invention. It is not to be taken as an admission that any of the documents or other material referred to was published, known or part of the common general knowledge at the priority date of any one of the claims of this specification.

It is an object of the present invention to overcome or at least alleviate one or more problems with prior art transport frames. It is a preferred object of the invention to provide a transport frame that more easily allows the transport frame to be collapsed and expanded, particularly by a single operator.

### SUMMARY OF THE INVENTION

According to a first aspect, the present invention provides a collapsible transport frame for transporting sheet material, including a first support frame, a second support frame, and a bracing arrangement connected to and extending between the first and second support frames. The bracing arrangement permits movement of the first support frame relative to the second support frame, between an expanded sheet support condition and a collapsed condition such that, in the expanded sheet support condition, the first and second support frames are braced in a spaced apart relationship and in the collapsed condition, the first and second support frames are substantially adjacent. The first support frame includes a wheel arrangement for engagement with a surface on which the transport frame is supported, the wheel arrangement facilitating movement of the first support frame relative to the second support frame such that the first support frame is movable in the collapsed condition away from the second support frame to the expanded condition and towards the second support frame from the expanded condition to the collapsed condition.

A collapsible transport frame according to the present invention advantageously facilitates movement between collapsed and expanded conditions thereof more easily than prior art arrangements, by the provision of the wheel arrangement which is associated with the first support frame. Advantageously, this facilitates movement between collapsed and expanded conditions by a single operator only.

In a preferred form, the collapsible transport frame is supported on a surface and the wheel arrangement is movable between a surface engaged position and a surface disengaged position, such that, in the surface engaged position, the wheel arrangement is in contact with the surface to facilitate movement of the first support frame relative to the second support frame and in the surface disengaged position, the wheel arrangement is disengaged from contact with the surface.

In a preferred form, the wheel arrangement further includes a cam lever, the cam lever being operable to move the wheel arrangement between the surface engaged position and the surface disengaged position.

The wheel arrangement may include a roller for contact with the surface, one or more wheels supported by and rotatable about an axis, or a ball partially encased in a housing such that a portion of the ball extends from the housing for contact with the surface, and is rotatable within the housing.

In an alternative preferred arrangement, the second support frame can also include a wheel arrangement.

A brake arrangement may be associated with the or each wheel arrangement and be operable to resist movement of the first and/or second support frame relative to the other support frame.

In a preferred form of the invention, the first and second support frames include a base member and one or more sheet bearing members extending upwardly from the base member. Preferably, one or more of the sheet bearing members is inclined at an angle relative to the base member.

In a further preferred form of the invention, the first and second support frames each include two sheet bearing members, the sheet bearing members being spaced apart at the base member and extending upwardly therefrom and being inclined at an angle such that the sheet bearing members converge towards or meet at a position remote from the base member to form an A-frame. The shape of the A-frame permits the sheet material to be transported in an inclined but upright position resting against the bearing members of the A-frame.

The bracing arrangement may include one or more elongate bracing members, preferably which are pivotally connected to the first and second support frames.

In a preferred form of the invention, the bracing arrangement includes first and second bracing members, which extend from the first support frame to the second support frame and which are pivotally connected at a position substantially midway between the first and second support frames.

Preferably, the first and second bracing members are arranged such that in the collapsed condition they are substantially parallel and in the expanded condition they extend transverse to each other.

The first or second support frame may further include a first brace locking arrangement which cooperates with the bracing arrangement and is operable to maintain the bracing arrangement locked in the expanded condition.

Further, the other of the first or second support frame may include a second brace locking arrangement which cooperates with the bracing arrangement and is operable to maintain the bracing arrangement locked in the collapsed condition.

In a preferred form of the invention, the collapsible transport frame further includes at least one locking member operable to sandwich sheet material between the first and second support frames and the locking member. Advantageously, this allows for the sheet material to be securely held to the collapsible transport frame for transport. The at least one locking member may be in facing relationship with at least one of the first and second support frames and is preferably in facing relationship with a bearing member of a first and/or second support frame.

In another preferred form of the invention, at least one locking member includes one or more abutment pad arrangements for engaging a facing surface of sheet material sandwiched between a locking member and the first and/or second support frames. Preferably, the abutment pad arrangements are slidable along the locking member so that the position of the abutment pad arrangements can be adjusted to suit the material being transported. By engaging the sheet material the abutment pad arrangements further secure the sheet material in place.

In another preferred form of the invention, the position of the locking member is adjustable by adjustment means, to vary the spacing between the locking member and the first and second support frames. The adjustment means may include a ratchet and a strap at a first end of the locking member, the strap extending between the locking member and one of the first and second support frames. Preferably, a second end of the locking member remote from the first end is moveable along the base member to vary the spacing between the second end of the locking member and the first and second support frames. Preferably, the base member is configured to engage the second end of the locking member to secure the second end of the locking member at a position along the base. The base member may include one or more spaced apart apertures for receipt of a locking pin, and the second end of the locking member may include an opening for receipt of a locking pin, the locking pin extending through the base member and second end of the locking member to secure the second end of the locking member at a position along the base.

Alternatively, the base member may include one or more spaced apart pins for receipt of the second end of the locking member to secure the locking member at a position along the base. The second end of the locking member may be shaped to engage a pin in the base member to secure the locking member at a position along the base. The second end of the locking member may be U-shaped.

In another preferred form of the invention, the first support frame further includes a secondary wheel arrangement for engagement with a surface on which the transport frame is supported when the transport frame is in the collapsed condition. The secondary wheel arrangement is arranged for engagement with the surface at a position spaced from the position of engagement of the surface by the first wheel arrangement, so that the second wheel arrangement can bear a portion of the weight of the transport frame. Preferably the arrangement is such that the first and second wheel arrangements can bear the full weight of the transport frame when the frame is in the collapsed condition. Advantageously, this further facilitates movement of the collapsible transport frame in the collapsed condition by a single operator only.

In a preferred form, the secondary wheel arrangement is movable between a surface engaged position and a surface disengaged position. The secondary wheel arrangement can include an arm which is pivotably connected to the first support frame and which has a wheel disposed at one end remote from the connection with the first support frame. Preferably the arm can pivot from the surface disengaged position, in which it is accommodated within or adjacent to the first support frame, to the surface engaged position, in which it is disposed at an angle to the first support frame with the wheel engaged with the surface. In this arrangement, the arm and the first support frame form a triangle.

The sheet material to be transported by the collapsible transport frame is preferably a rigid material and may be glass, fiberglass, marble, plastic or concrete.

Embodiments of the invention will now be described, by way of example only, with reference to the accompanying drawings. It is to be understood that the particularity of the drawings and embodiments does not supersede the generality of the preceding description of the invention.

### BRIEF DESCRIPTION OF THE DRAWINGS

FIG. 1 shows perspective view of a collapsible transport frame according to a first embodiment of the invention, in an expanded sheet support condition;

FIG. 2 shows an end view of the collapsible transport frame of FIG. 1;

FIG. 3 shows an exploded perspective view of the collapsible transport frame of FIGS. 1 and 2;

FIG. 4 shows a side view of the collapsible transport frame of FIG. 1 to 3 in a collapsed condition;

FIG. 5 shows a side view of the collapsible transport frame of FIG. 4 in an expanded sheet support condition;

FIG. 6 shows a further side view of the collapsible transport frame of FIG. 4;

FIG. 7 shows a perspective view of a loaded collapsible transport frame according to the invention.

FIG. 8 shows perspective view of a collapsible transport frame according to a second embodiment of the invention, in an expanded sheet support condition;

FIG. 9 shows an end view of the collapsible transport frame of FIG. 8;

FIG. 10 shows an exploded perspective view of the collapsible transport frame of FIGS. 8 and 9;

FIG. 11 shows a side view of the collapsible transport frame of FIG. 8 to 11 in a collapsed condition;

FIG. 12 shows a side view of the collapsible transport frame of FIG. 11 in an expanded sheet support condition;

FIG. 13 shows a further side view of the collapsible transport frame of FIG. 11;

FIG. 14 shows a perspective view of a loaded collapsible transport frame according to the second embodiment of the invention.

### DETAILED DESCRIPTION

Throughout the detailed description and the accompanying drawings, like referenced elements in the figures refer to like elements in the description.

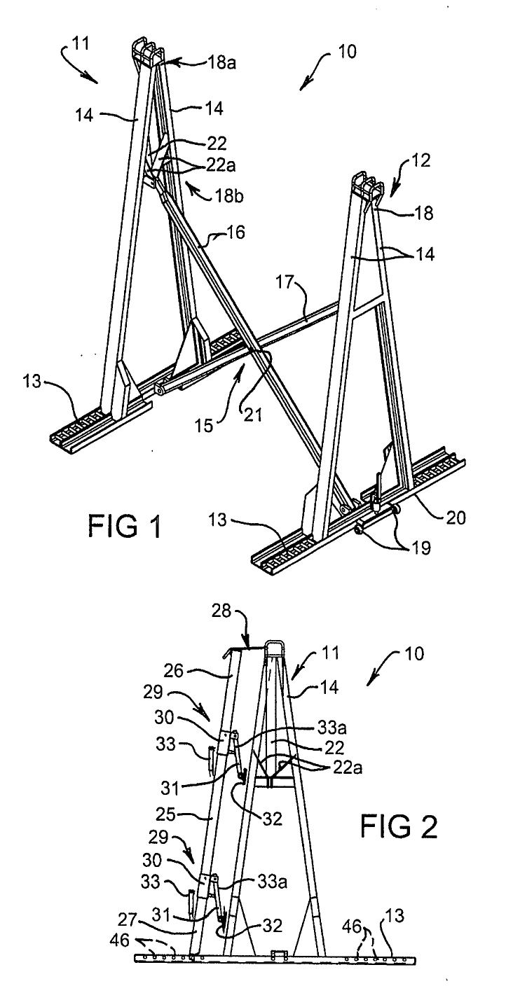

FIG. 1 shows a collapsible transport frame 10 in an expanded configuration or in a sheet support condition. The transport frame 10 includes a first support frame 11 and second support frame 12. Each of first and second support frames 11, 12 are secured to a base member 13. The first and second support frames 11, 12 can be secured to the base member 13 by welding, or by a nut and bolt arrangement or other suitable arrangement.

The first and second support frames 11, 12 each include a pair of sheet bearing members 14 which, in use, engage the face of a sheet material [not shown] to be transported.

Extending between first and second support frames 11, 12 is a bracing arrangement 15. In the present embodiment, the bracing arrangement 15 is in the form of two cross members 16, 17. The cross members 16, 17 are preferably 50 mm square steel tubes having a wall thickness of 5 mm. The cross member 16 extends from the base member 13 of the second support frame 12 to an upper portion 18a of the first support frame 11. The cross member 17 extends from the base member 13 of the first support frame 11 to an upper portion 18a of the second support frame 12.

The base member 13 of the second support frame 12 includes wheels 19 which can be lowered via a cam arrangement 20 between a surface engaged position and a surface disengaged position. In the surface engaged position, the transport frame 10 can be wheeled around, whereas when the wheels are in the surface disengaged position, the transport frame 10 rests stationary under its own weight and the weight of any material it might support.

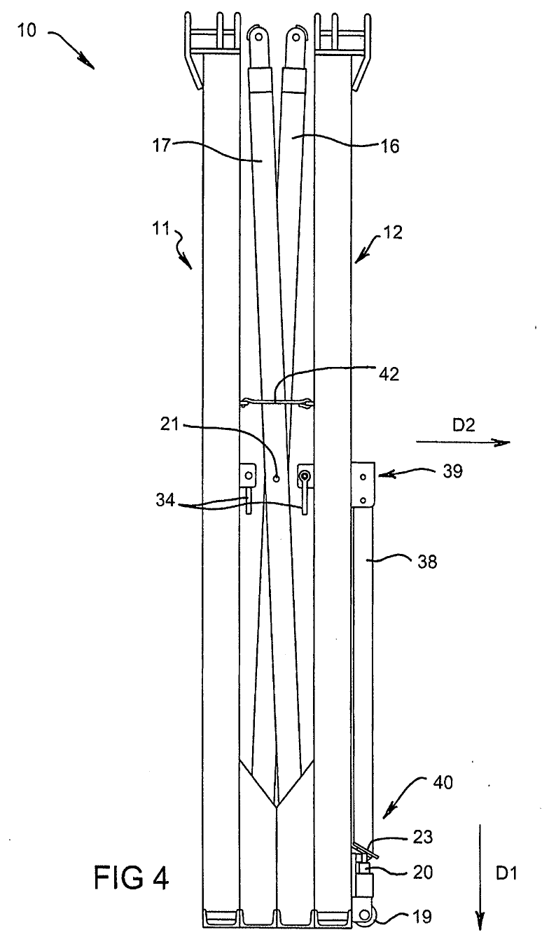

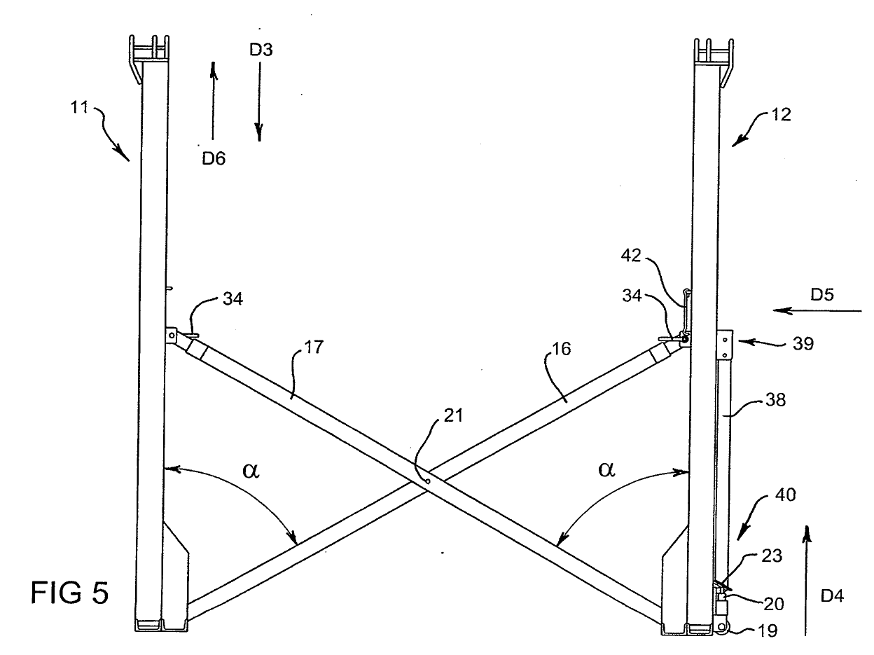

Cross members 16, 17 intersect at a point where they are secured by a pivot 21 which allows the cross members 16, 17 to pivot between the crossed position shown in FIG. 1 and a position in the collapsed condition of the transport frame 10 in which the cross members 16, 17 are substantially parallel. This is illustrated in side view in FIG. 4.

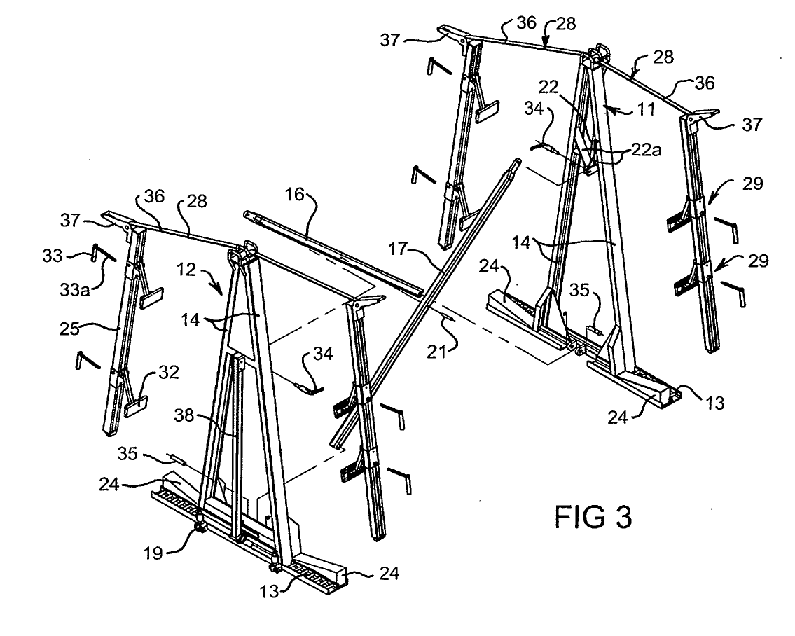

The first and second support frames 11, 12 further include a tongue portion 22 which is secured to the upper portion 18a of the frames 11, 12 and at the other end to intermediate portion 18b of the frames 11, 12. The operation of the tongue portion 22 will be further described with reference to FIG. 3.

FIG. 2 shows an end view of the transport frame 10 of FIG. 1. In this figure, the frame 10 further includes a locking member 25 positioned and lockable to clamp sheet material [not shown] between the sheet bearing member 14 of the first and second support frames 11, 12 and the locking member 25. Although not shown in FIG. 2, there is a locking member 25 associated with each sheet bearing member 14 of first support frame 11 and second support frame 12.

The locking member 25 has a first end 26 and a second end 27. The first end 26 of the locking member 25 is secured to the first support frame 11 by an adjustable locking strap arrangement 28. The second end 27 of the locking member 25 is U shaped to engage one of a plurality of spaced apart pins 46 to secure the locking member 25 in place. Alternatively, the second end 27 of the locking member 25 may be inserted in the apertures between adjacent pins 46 in the base member 13 to secure the locking member 25 in place. The base member 13 may further include bolt holes [not shown] in order to secure the transport frame 10 to the tray of a truck.

The locking member 25 further includes one or more abutment pad arrangements 29. Each abutment pad arrangement 29 includes a carriage 30 which is connected to the locking member 25 such that the carriage 30 can slide along the length of the locking member 25. The abutment pad arrangement 29 further includes an arm 31 which at one end is rotatably attached to the carriage 30 facing the sheet bearing member 14 of the first support frame 11. The arm 31 includes a pad 32 at its other end which engages the sheet material [not shown] to be transported. The carriage 30 further includes a handle 33 attached to a screw 33a. The screw 33a extends through the carriage 30 and against the arm 31 such that as the handle 33 is turned, the arm 31, and in turn, the pad 32 is moved toward and into contact with the sheet material [not shown] to be transported.

FIG. 3 shows an exploded view of the transport frame 10 of FIG. 1. Referring first to the arrangement of the cross members 16, 17, a brace locking arrangement or locking pin 34 is mounted to the respective first and second support frames 11, 12 such as by welding. The locking pin 34 extends through respective cross members 16, 17. The locking pin 34 is spring loaded such that when it is turned, it is biased to a position to lock the cross members 16, 17 at the first and second support members 11, 12 when the transport frame 10 is in the expanded sheet support condition. A pin 35 is located in the base member 13 of both the first support frame 11 and second support frame 12, and forms a pivot about which the cross members 16, 17 rotate. The base member 13 further includes inclined chocks 24 which assist to maintain the sheet material (not shown) bearing against the sheet bearing member 14.

The first and second support frames 11, 12 further include an elongate, concave tongue portion 22 which is secured to the upper portion 18a of the first and second support frames 11, 12 and at the other end to intermediate portion 18b of the first and second support frames 11, 12. The ends of the cross members 16, 17 engage upper ends of the tongue portions 22 when commencing movement from the collapsed condition to the expanded condition and slide downwardly along the length of the tongue portion 22 when moving to the expanded sheet support condition. Each tongue portion 22 further includes a V shaped member 22a at the bottom end thereof in order to guide each cross member 16, 17 into alignment with the locking pin 34 when the cross members 16, 17 reach the bottom of the tongue portion 22.

The first and second support frames 11, 12 include the adjustable locking strap arrangement 28 which extends between a respective first and second support frame 11, 12 and each associated locking member 25 in order to secure the locking member 25 in engagement with the sheet material [not shown] to be transported by the transport frame 10. The adjustable locking strap arrangement 28 includes a strap 36 and a ratchet 37 which is secured to the first end 26 of the locking member 25. The strap 36 extends from the upper portion 18a of the first and second frames 11, 12 where it is secured, to the first end 26 (FIG. 2) of the locking member 25, where it is adjustably secured by way of the ratchet 37. Alternatively, a chain could be used in place of the ratchet strap arrangement 128.

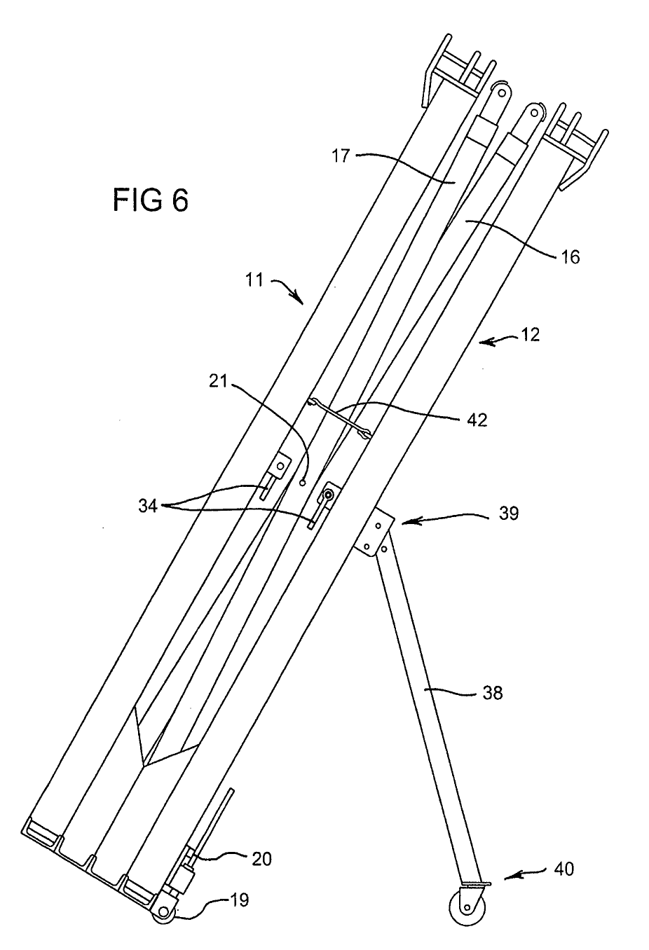

The second support frame 12 further includes a secondary wheel arrangement in the form of an elongate lever 38 having a first end 39 and a second end 40 as shown in FIG. 4. The first end 39 is rotatably secured midway along the second support frame 12 and the second end 40 extends towards the base member 13. The second end 40 of the elongate lever 38 includes a wheel 41 (see FIG. 6). The operation of the elongate lever 38 will be further described in operation of the transport frame 10 with reference to FIG. 6.

FIG. 4 shows the transport frame 10 in a collapsed condition in which each of the first and second support frames 11, 12 are closely adjacent and generally parallel. The transport frame is retained in the collapsed portion by a hook 42 which extends between the first support frame 11 and the second support frame 12. In order to move to the expanded sheet support condition as shown in FIG. 5, the hook 42 is unhooked from either the first or second support frame 11, 12. The cam arrangement 20 (FIG. 5) is then engaged, by pulling the cam lever 23 which moves the wheels 19 in the direction D1 and into contact with the surface on which the transport frame 10 is supported and this raises the second support frame 12 out of contact with that surface so that the wheels 19 are partially supporting the transport frame 10. The transport frame 10 is moved to the expanded sheet support condition by the pulling the second support frame 12 in the direction of D2. The wheels 19, which are in contact with the support surface, facilitate movement of the second support frame 12 relative to the first support frame 11. The overall weight of the transport frame 10 and the frictional force between the support surface and the first support frame 11 typically will prevent the first support frame 11 from moving together with the second support frame 12 when the second support frame 12 is moved in direction D2. Advantageously, this arrangement allows the transport frame 10 to be expanded by one person only.

By pulling the second support frame 12 in direction D2 in FIG. 4, the cross members 16 and 17 are rotated through an angle \acute{α} and they each slide down the tongue portion [not shown] of the first and second support frames 11, 12 in direction D3 as shown in FIG. 5. FIG. 5 shows the transport frame in the expanded sheet support condition and shows the pivot 21 which extends through cross members 16, 17.

The transport frame 10 is secured in the expanded sheet support condition by turning the spring loaded locking pins 34 in a direction such that they act to lock the cross members 16, 17 at the first and second support frames 11, 12 in the position shown in FIG. 5. The cam arrangement 20 is then released by pulling the cam lever 23, which moves the wheels 19 in the direction D4, raising the wheels 19 out of contact with the support surface such that the second support frame 12 rests on the support surface. The transport frame 10 can then be loaded with sheet material [not shown] to be transported.

FIG. 5 shows the transport frame 10 in an expanded sheet support condition in which each of the first and second support frames 11, 12 rest in contact with the support surface. In order to move to the collapsed condition as shown in FIG. 4, the cross members 16, 17 are unlocked from their position by turning the spring loaded locking pins 34, in a direction such that they act to unlock the cross members 16, 17. The cam arrangement 20 is then engaged, by pulling the cam lever 23 which moves the wheels 19 in the direction D1 (as shown in FIG. 4) and into contact with the support surface to raise the second frame support 12 out of contact with the support surface. The transport frame 10 is moved to the collapsed condition by pushing the second support frame 12 in the direction of D5. The wheels 19 facilitate movement of the second support frame 12 relative to the first support frame 11. The overall weight of the transport frame 10 and the frictional force between the support surface and the first support frame 11 prevent the first support frame 11 from moving together with the second support frame 12 when the second support frame 12 is moved in direction D5. Advantageously, this arrangement allows the transport frame 10 to be collapsed by one person only.

By pushing the second support frame 12 in direction D5 in FIG. 5, the cross members 16, and 17 are rotated through angle \acute{α} about the pivot 21 and slide up the tongue portion [not shown] of the first and second support frames 11, 12 in the direction D6. The transport frame 10 is secured in the collapsed condition by the hook 42 which extends between the first support frame 11 and the second support frame 12. The cam arrangement 20 is then released by pulling the cam lever 23 which moves the wheels 19 in direction D4 raising the wheels 19 out of contact with the support surface such that the second support frame 12 regains contact with the support surface.

FIG. 6 shows the transport frame 10 arranged so that it can be moved in the collapsed condition. The cam arrangement 20 is first engaged, by pulling the cam lever 23 which moves the wheels 19 in direction D1 (as shown in FIG. 4) and into contact with the support surface and in turn raises the second frame support 12 out of contact with the support surface such that the wheels 19 are partially supporting the transport frame 10. The transport frame 10 is then able to be moved by tilting the transport frame 10 such that the wheels 19 are solely supporting the transport frame 10. In order to further facilitate the portability of the transport frame, the elongate lever 38 can be extended outwardly from the second support frame 12 such that the wheel 41 of the elongate lever 38 is also in contact with the support surface and also provides support for the transport frame 10. Advantageously, this arrangement allows the transport frame 10 to be moved by one person only.

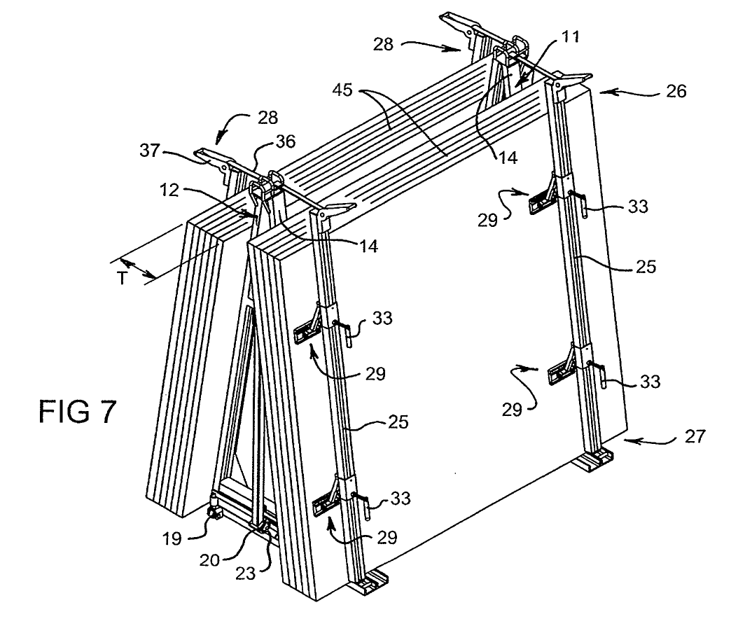

FIG. 7 illustrates a transport frame 10 in the expanded sheet support condition including a stack of sheets of material 45 which have been loaded and secured to the transport frame 10. One or more sheets of material 45 are placed between the first and second support frames 11, 12 and the locking member 25. The placement of the sheet material is effected by firstly completely removing the locking members 25 and thereafter placing the sheets 45 against the sheet bearing members 14. When sufficient sheets have been loaded, the locking members are returned to a position of facing engagement with the material sheet 45. Thus, the sheet material 45 is in contact with the sheet bearing members 14 and the locking member 25. The second end 27 of the locking member 25 is then engaged with the base member 13 as previously described to secure that end of the locking member 25 in place. The thickness T of the sheet material 45 dictates the position of the locking member 25 along the length of the base member 13. Once the locking member 25 is secured at the base member 13, the first end 26 of the locking member 25 is secured to the first support frame 11 by the adjustable locking strap arrangement 28. The ratchet 37 of the adjustable locking strap arrangement 28 is operated to secure the first end 26 of the locking member 25. The abutment pad arrangements 29 can then be adjusted along the locking members 25 to by turning the handle 33 of the abutment pad arrangement 29 which moves the pad 32 toward and into contact with the sheet material 45. Alternatively, a chain could be used in place of the ratchet strap arrangement 128.

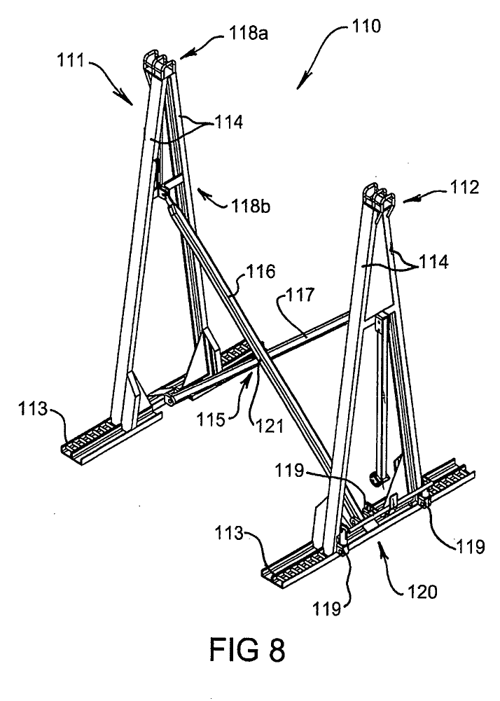

FIG. 8 shows a collapsible transport frame 110 in an expanded configuration or in a sheet support condition. The transport frame 110 includes a first support frame 111 and second support frame 112. Each of first and second support frames 111, 112 are secured to a base member 113. The first and second support frames 111, 112 can be secured to the base member 113 by welding, or by a nut and bolt arrangement or other suitable arrangement.

The first and second support frames 111, 112 each include a pair of sheet bearing members 114 which, in use, engage the face of a sheet material [not shown] to be transported.

Extending between first and second support frames 111, 112 is a bracing arrangement 115. In the present embodiment, the bracing arrangement 115 is in the form of two cross members 116, 117. The cross members 116, 117 are preferably 50 mm square steel tubes having a wall thickness of 5 mm. The cross member 116 extends from the base member 113 of the second support frame 112 to an upper portion 118a of the first support frame 111. The cross member 117 extends from the base member 113 of the first support frame 111 to an upper portion 118a of the second support frame 112.

The base member 113 of the second support frame 112 includes wheels 119 which can be lowered via a cam or foot pedal arrangement 120 between a surface engaged position and a surface disengaged position. In the surface engaged position, the transport frame 110 can be wheeled around, whereas when the wheels are in the surface disengaged position, the transport frame 110 rests stationary under its own weight and the weight of any material it might support.

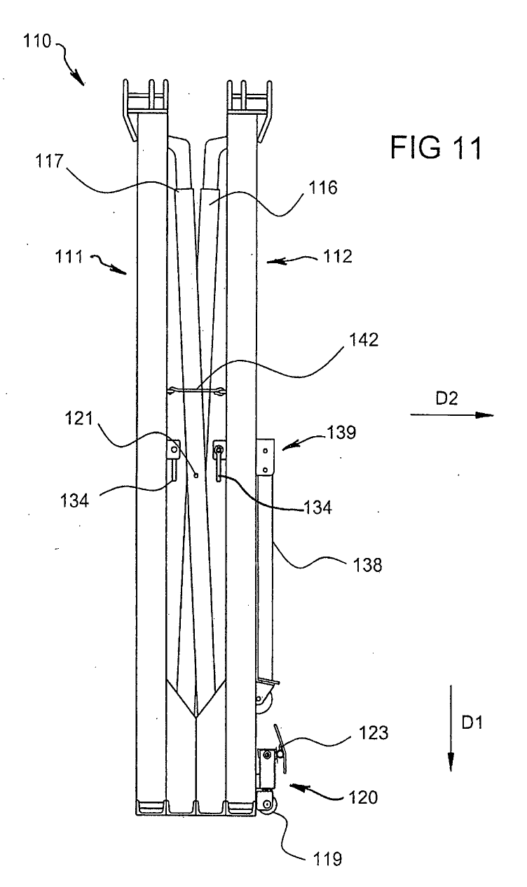

Cross members 116, 117 intersect at a point where they are secured by a pivot 121 which allows the cross members 116, 117 to pivot between the crossed position shown in FIG. 8 and a position in the collapsed condition of the transport frame 110 in which the cross members 116, 117 are substantially parallel. This is illustrated in side view in FIG. 11.

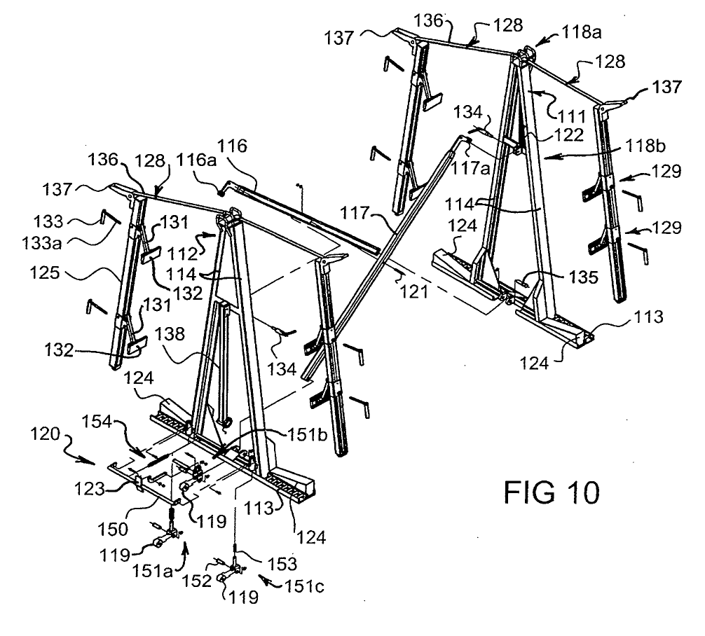

The first and second support frames 111, 112 further include an elongate cage member 122 which is secured to the upper portion 118a of the frames 111, 112 and at the other end to intermediate portion 118b of the frames 111, 112. The operation of the elongate cage member 22 will be further described with reference to FIG. 10.

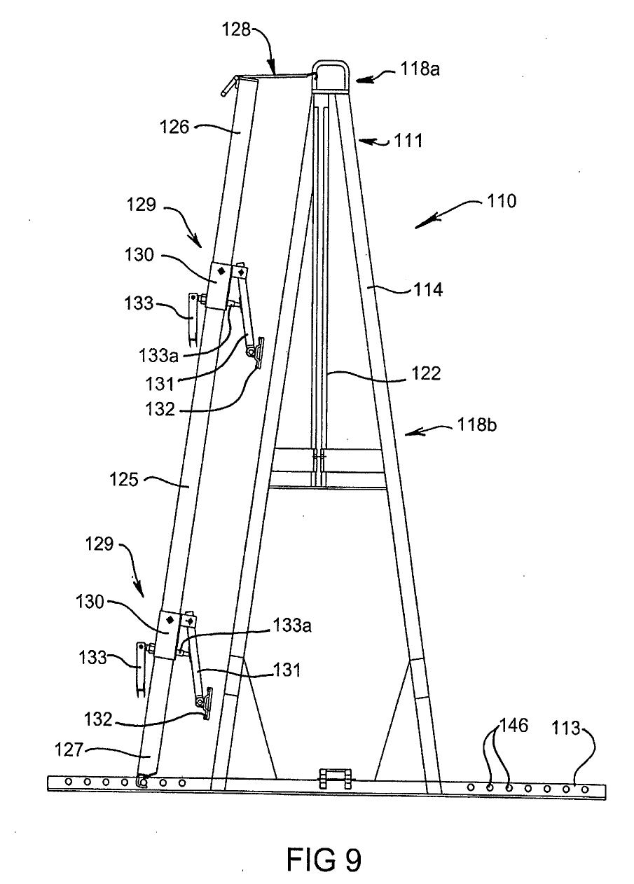

FIG. 9 shows an end view of the transport frame 110 of FIG. 8. In this figure, the frame 110 further includes a locking member 125 positioned and lockable to clamp sheet material [not shown] between the sheet bearing member 114 of the first and second support frames 111, 112 and the locking member 125. Although not shown in FIG. 9, there is a locking member 125 associated with each sheet bearing member 114 of first support frame 111 and second support frame 112.

The locking member 125 has a first end 126 and a second end 127. The first end 126 of the locking member 125 is secured to the first support frame 111 by an adjustable locking strap arrangement 128. The second end 127 of the locking member 125 is U shaped to engage one of a plurality of spaced apart pins 146 to secure the locking member 125 in place. Alternatively, the second end 127 of the locking member 125 may be inserted in the apertures between adjacent pins 146 in the base member 113 to secure the locking member 125 in place. The base member 113 may further include bolt holes [not shown] in order to secure the transport frame 110 to the tray of a truck.

The locking member 125 further includes one or more abutment pad arrangements 129. Each abutment pad arrangement 129 includes a carriage 130 which is connected to the locking member 125 such that the carriage 130 can slide along the length of the locking member 125. The abutment pad arrangement 129 further includes an arm 131 which at one end is rotatably attached to the carriage 130 facing the sheet bearing member 114 of the first support frame 111. The arm 131 includes a pad 132 at its other end which engages the sheet material [not shown] to be transported. The carriage 130 further includes a handle 133 attached to a screw 133a. The screw 133a extends through the carriage 130 and against the arm 131 such that as the handle 133 is turned, the arm 131, and in turn, the pad 132 is moved toward and into contact with the sheet material [not shown] to be transported.

The first and second support frames 111, 112 further include an elongate cage member 122 which is secured to the upper portion 118a of the first and second support frames 111, 112 and at the other end to intermediate portion 118b of the first and second support frames 111, 112. The operation of the elongate member 122 will be further described with reference to FIG. 10.

FIG. 10 shows an exploded view of the transport frame 110 of FIG. 8. Referring first to the arrangement of the cross members 116, 117, a brace locking arrangement or locking pin 134 is mounted to the respective first and second support frames 111, 112 such as by welding. The locking pin 134 extends through respective cross members 116, 117. The locking pin 134 is spring loaded such that when it is turned, it is biased to a position to lock the cross members 116, 117 at the first and second support members 111, 112 when the transport frame 110 is in the expanded sheet support condition. A pin 135 is located in the base member 113 of both the first support frame 111 and second support frame 112, and forms a pivot about which the cross members 116, 117 rotate. The base member 113 further includes inclined chocks 124 which assist to maintain the sheet material (not shown) bearing against the sheet bearing member 114.

The first and second support frames 111, 112 further include an elongate cage member 122 which is secured to the upper portion 118a of the first and second support frames 111, 112 and at the other end to intermediate portion 118b of the first and second support frames 111, 112. The ends 116a, 117a of the cross members 116, 117 include a roller bearing which engages and is retained in the elongate cage member in order to guide the movement of the cross members 116, 117 when commencing movement from the collapsed condition to the expanded condition. In this case, the ends 116a, 117a of the cross members slide downwardly along the length of the elongate cage member 122 when moving to the expanded sheet support condition.

The first and second support frames 111, 112 include the adjustable locking strap arrangement 128 which extends between a respective first and second support frame 111, 112 and each associated locking member 125 in order to secure the locking member 125 in engagement with the sheet material [not shown] to be transported by the transport frame 110. The adjustable locking strap arrangement 128 includes a strap 136 and a ratchet 137 which is secured to the first end 126 (FIG. 9) of the locking member 125. The strap 136 extends from the upper portion 118a of the first and second frames 111, 112 where it is secured, to the first end 126 (FIG. 9) of the locking member 125, where it is adjustably secured by way of the ratchet 137. Alternatively, a chain could be used in place of the ratchet strap arrangement 128.

The first support frame 111 further includes a secondary wheel arrangement in the form of an elongate lever 138 having a first end 139 and a second end 140 as shown in FIG. 11. The first end 139 is rotatably secured midway along the first support frame 111 and the second end 140 extends towards the base member 113. The second end 140 of the elongate lever 138 includes a wheel 141 (see FIG. 11). The operation of the elongate lever 138 will be further described in operation of the transport frame 110 with reference to FIG. 11.

The base member 113 of the first support frame 111 includes wheels 119 which can be lowered via a cam or foot pedal arrangement 120 between a surface engaged position and a surface disengaged position. In the surface engaged position, the transport frame 110 can be wheeled around, whereas when the wheels are in the surface disengaged position, the transport frame 110 rests stationary under its own weight and the weight of any material it might support. The foot pedal arrangement 120 includes a foot pedal 123 attached to an elongate member 150. The elongate member 150 is in contact with a housing 151a, 151b and 151c which houses each of the wheels 119. Housings 151a and 151c are located on one side of the base member 113 while housing 151b is located on the other side of the base member 113. The spacing of the housings 151a, 151b and 151c and their wheels 119 provides more stability for the transport frame 110 when the foot pedal arrangement 120 is in the surface engaged position. The foot pedal 123 (via elongate member 150) is used to raise or lower the wheels between the surface engaged position and surface disengaged position. Each housing 151a, 151b, 151c having wheels 119 also includes an axle 152 about which the wheels 119 can rotate and a bearing 153 to assist in movement of the housing 151a, 151b, 151c and wheel 119 via the foot pedal 123 between the surface engaged position and the surface disengaged position. Due to the location of housing 151b on the other side of the base member 113, a strut arrangement 154 is in contact with the housing 151b and the elongate member 150 of the foot pedal arrangement 120 such that upon engaging the foot pedal 123 the elongate member 150 via the strut arrangement 154 allows movement of the housing 151b and wheel 119 between the surface engaged position and the surface disengaged position at the same time as housings 151a and 151c. Advantageously, the foot pedal arrangement 120 allows a single operator of the transport frame 110 to hold the upper portion of the first support frame 110 with their hands and engage the foot pedal arrangement 120 with their foot to more easily and quickly move the transport frame between the collapsed condition and the expanded sheet support condition.

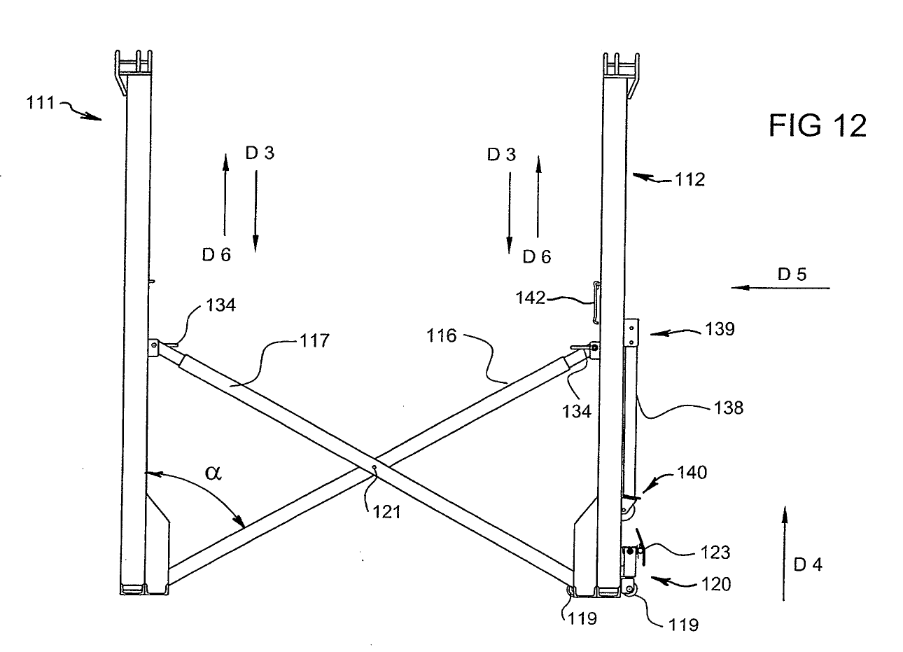

FIG. 11 shows the transport frame 110 in a collapsed condition in which each of the first and second support frames 111, 112 are closely adjacent and generally parallel. The transport frame is retained in the collapsed position by a hook 142 which extends between the first support frame 111 and the second support frame 112. In order to move to the expanded sheet support condition as shown in FIG. 12, the hook 142 is unhooked from either the first or second support frame 111, 112. The foot pedal arrangement 120 (FIG. 12) is then engaged, by pushing the foot pedal 123 which moves the wheels 119 in the direction D1 and into contact with the surface on which the transport frame 110 is supported and this raises the second support frame 112 out of contact with that surface so that the wheels 119 are partially supporting the transport frame 110. The transport frame 110 is moved to the expanded sheet support condition by the pulling the second support frame 112 in the direction of D2. The wheels 119, which are in contact with the support surface, facilitate movement of the second support frame 112 relative to the first support frame 111. Preferably, three wheels 119 are used in order to improve ease of movement in the direction D2. The overall weight of the transport frame 110 and the frictional force between the support surface and the first support frame 111 typically will prevent the first support frame 111 from moving together with the second support frame 112 when the second support frame 112 is moved in direction D2. Advantageously, this arrangement allows the transport frame 110 to be expanded by one person only.

By pulling the second support frame 112 in direction D2 in FIG. 11, the cross members 16 and 17 are rotated through an angle \acute{α} and they each slide down the elongate cage member [not shown] of the first and second support frames 111, 112 in direction D3 as shown in FIG. 12. FIG. 12 shows the transport frame in the expanded sheet support condition and shows the pivot 121 which extends through cross members 116, 117.

The transport frame 110 is secured in the expanded sheet support condition by turning the spring loaded locking pins 134 in a direction such that they act to lock the cross members 116, 117 at the first and second support frames 111, 112 in the position shown in FIG. 12. The foot pedal arrangement 120 is then released by pushing the foot pedal 123, which moves the wheels 119 in the direction D4, raising the wheels 119 out of contact with the support surface such that the second support frame 112 rests on the support surface. The transport frame 110 can then be loaded with sheet material [not shown] to be transported.

FIG. 12 shows the transport frame 110 in an expanded sheet support condition in which each of the first and second support frames 111, 112 rest in contact with the support surface. In order to move to the collapsed condition as shown in FIG. 11, the cross members 116, 117 are unlocked from their position by turning the spring loaded locking pins 134, in a direction such that they act to unlock the cross members 116, 117. The foot pedal arrangement 120 is then engaged, by pushing the foot pedal 123 which moves the wheels 119 in the direction D1 (as shown in FIG. 11) and into contact with the support surface to raise the second frame support 112 out of contact with the support surface. The transport frame 110 is moved to the collapsed condition by pushing the second support frame 112 in the direction of D5. The wheels 119 facilitate movement of the second support frame 112 relative to the first support frame 111. The overall weight of the transport frame 110 and the frictional force between the support surface and the first support frame 111 prevent the first support frame 111 from moving together with the second support frame 112 when the second support frame 112 is moved in direction D5. Advantageously, this arrangement allows the transport frame 110 to be collapsed by one person only.

By pushing the second support frame 112 in direction D5 in FIG. 12, the cross members 116, and 117 are rotated through angle \acute{α} about the pivot 121 and slide up the elongate cage member [not shown] of the first and second support frames 111, 112 in the direction D6. The transport frame 110 is secured in the collapsed condition by the hook 142 which extends between the first support frame 111 and the second support frame 112. The foot pedal arrangement 120 is then released by pushing the foot pedal 123 which moves the wheels 119 in direction D4 raising the wheels 119 out of contact with the support surface such that the second support frame 112 regains contact with the support surface.

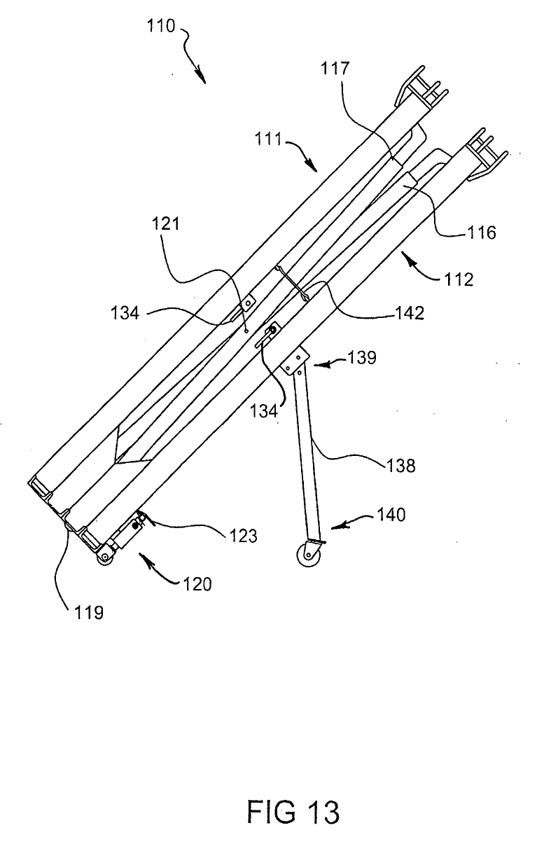

FIG. 13 shows the transport frame 110 arranged so that it can be moved in the collapsed condition. The foot pedal arrangement 120 is first engaged, by pushing the foot pedal 123 which moves the wheels 119 in direction D1 (as shown in FIG. 11) and into contact with the support surface and in turn raises the second frame support 112 out of contact with the support surface such that one or more of the wheels 119 are partially supporting the transport frame 110. The transport frame 110 is then able to be moved by tilting the transport frame 110 such that one or more of the wheels 119 are solely supporting the transport frame 110. In order to further facilitate the portability of the transport frame, the elongate lever 138 can be extended outwardly from the second support frame 112 such that the wheel 141 of the elongate lever 138 is also in contact with the support surface and also provides support for the transport frame 110. Advantageously, this arrangement allows the transport frame 110 to be moved by one person only.

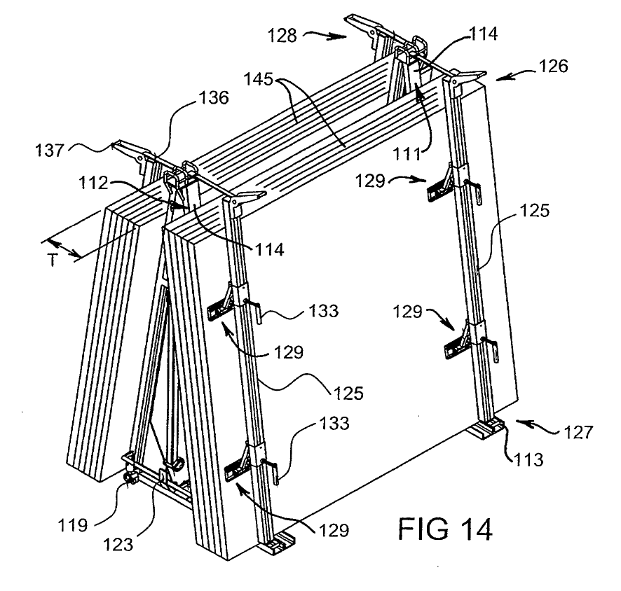

FIG. 14 illustrates a transport frame 110 in the expanded sheet support condition including a stack of sheets of material 145 which have been loaded and secured to the transport frame 110. One or more sheets of material 145 are placed between the first and second support frames 111, 112 and the locking member 125. The placement of the sheet material is effected by firstly completely removing the locking members 125 and thereafter placing the sheets 145 against the sheet bearing members 114. When sufficient sheets have been loaded, the locking members are returned to a position of facing engagement with the material sheet 145. Thus, the sheet material 145 is in contact with the sheet bearing members 114 and the locking member 125. The second end 127 of the locking member 125 is then engaged with the base member 113 as previously described to secure that end of the locking member 125 in place. The thickness T of the sheet material 145 dictates the position of the locking member 125 along the length of the base member 113. Once the locking member 125 is secured at the base member 113, the first end 126 of the locking member 125 is secured to the first support frame 111 by the adjustable locking strap arrangement 128. The ratchet 137 of the adjustable locking strap arrangement 128 is operated to secure the first end 126 of the locking member 125. The abutment pad arrangements 129 can then be adjusted along the locking members 125 to by turning the handle 133 of the abutment pad arrangement 129 which moves the pad 132 toward and into contact with the sheet material 145.

Although this invention has been illustrated by reference to specific embodiments, it will be apparent to those skilled in the art that various changes and modifications may be made that clearly fall within the scope of the invention. The invention is intended to be protected broadly within the spirit and scope of the appended claims.

The invention claimed is:

1. A collapsible transport frame for transporting sheet material, including:
a first support frame;
a second support frame;
a bracing arrangement connected to and extending between the first and second support frames which permits movement of the first support frame relative to the second support frame, between an expanded sheet support condition and a collapsed condition;
such that, in the expanded sheet support condition, the first and second support frames are braced in a spaced apart relationship and in the collapsed condition, the first and second support frames are substantially adjacent;
wherein the first support frame includes a wheel arrangement for engagement with a surface on which the transport frame is supported, the wheel arrangement facilitating movement of the first support frame relative to the second support frame such that the first support frame is movable in the collapsed condition away from the second support frame to the expanded condition and towards the second support frame from the expanded condition to the collapsed condition.

2. A collapsible transport frame according to claim 1, wherein the collapsible transport frame is supported on a surface, and the wheel arrangement is movable between a surface engaged position and a surface disengaged position, such that, in the surface engaged position, the wheel arrangement is in contact with the surface; to facilitate movement of the first support frame relative to the second support frame; and in the surface disengaged position, the wheel arrangement is disengaged from contact with the surface.

3. A collapsible transport frame according to claim 2, wherein the wheel arrangement further includes a cam lever, the cam lever bearing operable to move the wheel arrangement between the surface engaged position and the surface disengaged position.

4. A collapsible transport frame according to claim 1, wherein the wheel arrangement includes a roller for rolling contact with the surface.

5. A collapsible transport frame according to claim 1, wherein the wheel arrangement includes one or more wheels supported by and rotatable about an axis for contact with the surface.

6. A collapsible transport frame according to claim 1, wherein the wheel arrangement includes a ball partially encased in a housing such that a portion of the ball extends from the housing for contact with the surface, and is rotatable within the housing.

7. A collapsible transport frame according to claim 1, wherein the second support frame includes a wheel arrangement.

8. A collapsible transport frame according to claim 1, further including a brake arrangement associated with the wheel arrangement and operable to resist movement of the first support frame relative to the second support frame.

9. A collapsible transport frame according to claim 1, wherein the first and second support frames include a base member and one or more sheet bearing members extending upwardly from the base member.

10. A collapsible transport frame according to claim 9, wherein one or more of the sheet bearing members is inclined at an angle relative to the base member.

11. A collapsible transport frame according to claim 9, wherein the first and second support frames each include two sheet bearing members, the sheet bearing members being spaced apart at the base member and extending upwardly thereform and being inclined at an angle such that the sheet bearing members converge toward a position remote from the base member to form an A-frame.

12. A collapsible transport frame according to claim 1, wherein the bracing arrangement includes one or more elongate bracing members, the one or more bracing members being pivotally connected to the first and second support frames.

13. A collapsible transport frame according to claim 12, wherein the bracing arrangement includes first and second bracing members, the first and second bracing members extending from the first support frame to the second support frame and being pivotally connected at a position substantially midway between the first and second support frames.

14. A collapsible transport frame according to claim 13, wherein the first and second bracing members are arranged such that in the collapsed condition they are substantially parallel and in the expanded condition they extend transverse to each other.

15. A collapsible transport frame according to claim 1, wherein the first or second support frame further includes a first brace locking arrangement which cooperates with the bracing arrangement and is operable to maintain the bracing arrangement locked in the expanded condition.

16. A collapsible transport frame according to claim 15, wherein the other of the first or second support frame further includes a second brace locking arrangement which cooperates with the bracing arrangement and is operable to maintain the bracing arrangement in the collapsed condition.

17. A collapsible transport frame according to claim 15, wherein the first brace locking arrangement includes a locking pin, the locking pin engaging the bracing arrangement and operable to move the first brace locking arrangement between locked and unlocked positions.

18. A collapsible transport frame according to claim 16, wherein the second brace locking arrangement includes a locking pin, the locking pin engaging the bracing arrangement and operable to move the second brace locking arrangement between locked and unlocked positions.

19. A collapsible transport frame according to claim 1, further including at least one locking member operable to sandwich sheet material between the first and second support frames and the locking member.

20. A collapsible transport frame according to claim 19, wherein the at least one locking member is in facing relationship with at least one of the first and second support frames.

21. A collapsible transport frame according to claim 20 when dependent on claim 9, wherein the at least one locking member is in facing relationship with a bearing member of the first and second support frames.

22. A collapsible transport frame according to claim 19, wherein the at least one locking member includes one or more abutment pad arrangements for engaging a facing surface of the sheet material sandwiched between a locking member and the first and second support frames.

23. A collapsible transport frame according to claim 22, wherein the abutment pad arrangements are slidable along the at least one locking member so that the position of the abutment pad arrangements can be adjusted to suit the material being transported.

24. A collapsible transport frame according to claim 19, wherein the position of the at least one locking member is adjustable by adjustment means, to vary the spacing between the locking member and the first and second support frames.

25. A collapsible transport frame according to claim 24, wherein the adjustment means includes a ratchet and a strap at a first end of a said locking member, the strap extending between said locking member and one of the first and second support frames.

26. A collapsible transport frame according to claim 24, wherein a second end of the locking member remote from the first end is moveable along the base member to vary the spacing between the second end of the locking member and the first and second support frames.

27. A collapsible transport frame according to claim 24, wherein the base member is configured to engage the second end of the locking member to secure the second end of the locking member at a position along the base.

28. A collapsible transport frame according to claim 27, wherein the base member includes one or more spaced apart apertures for receipt of a locking pin, and the second end of the locking member includes an opening for receipt of a locking pin, the locking pin extending through the base member and second end of the locking member to secure the second end of the locking member at a position along the base.

29. A collapsible transport frame according to claim 26, wherein the base member includes one or more spaced apart pins for receipt of the second end of the locking member to secure the locking member at a position along the base.

30. A collapsible transport frame according to claim 29, wherein the second end of the locking member is shaped to engage a pin in the base member to secure the locking member at a position along the base.

31. A collapsible transport frame according to claim 30, wherein the second end of the locking member is U-shaped.

32. A collapsible transport frame according claim 1, wherein the first support frame further includes a secondary wheel arrangement for engagement with a surface on which the transport frame is supported, the second wheel arrangement facilitating movement of the collapsible transport frame in the collapsed condition.

33. A collapsible transport frame according to claim 32, wherein the collapsible transport frame is supported on a surface, and the secondary wheel arrangement is movable between a surface engaged position and a surface disengaged position, such that, in the surface engaged position, the secondary wheel arrangement is in contact with the surface to facilitate movement of the collapsible transport frame and in the surface disengaged position, the secondary wheel arrangement is disengaged from contact with the surface.

34. A collapsible frame according to claim 33, wherein the secondary wheel arrangement includes an arm which is pivotably connected to the first support frame and which has a wheel disposed at one end remote from the connection with the first support frame, the arm being pivotable from the surface disengaged position, in which it is accommodated within or adjacent to the first support frame, to the surface engaged position, in which it is disposed at an angle to the first support frame with the wheel engaged with the surface.
